(19) United States
(12) Patent Application Publication
(10) Pub. No.: US 2026/0341621 A1
(43) Pub. Date: Oct. 29, 2026

(54) OVERLOAD PROTECTION DEVICE FOR MULTI-NATIONAL POWER CONVERTER

(71) Applicant: DONGGUAN BEST TRAVEL ELECTRONICS CO.,LTD., Dongguan (CN)

(72) Inventors: Guangli ZENG, Dongguan (CN); Chengbing WANG, Dongguan (CN); Feng WANG, Dongguan (CN)

(21) Appl. No.: 19/703,189

(22) Filed: Jun. 10, 2026

Related U.S. Application Data
(63) Continuation of application No. PCT/CN2025/070680, filed on Jan. 6, 2025.

(30) Foreign Application Priority Data
Dec. 13, 2023 (CN) 202311717256.X

(51) Int. Cl. H01H 85/165; H01H 85/143

(52) U.S. Cl. CPC H01H 85/165; H01H 85/143

(57) ABSTRACT

An overload protection device for a multi-national power converter. The multi-national power converter includes a main body upper cover, a main body lower cover, an American standard pin assembly, and a British standard pin assembly. A socket hole is defined on the main body upper cover. The overload protection device includes: a fuse holder; a fuse tube; a lower conduction piece; and an upper conduction piece. An installation frame is formed inside the fuse holder. The lower conduction piece includes a lower conduction clamping portion. The upper conduction piece includes an upper conduction clamping portion. An installation cover is formed on a lower end surface of the fuse holder; a fuse tube insertion hole is defined on the main body lower cover; at least one withdrawal clearance slot is recessed on the fuse tube insertion hole. A gap is defined between the installation cover and the withdrawal clearance slot.

### CROSS-REFERENCE TO RELATED APPLICATIONS

The present application is a continuation-application of International (PCT) Patent Application No. PCT/CN2025/070680, filed on Jan. 6, 2025, which claims foreign priority of Chinese Patent Application No. 202311717256.X, filed on Dec. 13, 2023, in the China National Intellectual Property Administration. The entire contents of International (PCT) Patent Application No. PCT/CN2025/070680 and Chinese Patent Application No. 202311717256.X are hereby incorporated by reference in its entirety.

### TECHNICAL FIELD

The present disclosure relates to the technical field of power converters, and in particular, to an overload protection device for a multi-national power converter.

### BACKGROUND

As socket standards are not universally harmonized across countries, a single type of plug cannot be used worldwide. When traveling to different nations, it is necessary to configure plugs compatible with the respective country's standard in order to supply power to portable electronic devices. If visiting several countries in a single trip, consumers have to carry power plugs corresponding to each nation, posing significant inconvenience to individuals engaged in international travel or business trips.

Consequently, power converters adaptable to the socket standards of various countries have become prevalent in the market. To enhance the safety performance of these power converters, some models incorporate a fuse tube. When the current reaches a certain threshold, the fuse tube blows, thereby protecting the circuit.

The conventional configuration of power converters available on the market typically involves sockets on the housing, with conductive terminals positioned on the socket sidewalls to establish electrical contact with the fuse tube. During use, this design is prone to leakage, which may lead to electric shock and create potential safety hazards. Additionally, it occupies considerable product space, hindering efforts toward product miniaturization.

Furthermore, during the operation of power converters, because the outer edge dimensions of sockets in some countries are not subject to safety regulations, many sockets on the market feature minimal edge dimensions. When the pins are extended for use, if the fuse tube is not entirely contained within a contact area between the plug and the socket, there exists a risk of the fuse tube being pulled out. This may result in safety hazards such as leakage and electric shock. Particularly, if children remove the fuse tube out of curiosity during use, it presents a significant safety concern, resulting in low operational safety.

### SUMMARY OF THE DISCLOSURE

An overload protection device for a multi-national power converter;

wherein the multi-national power converter comprises a main body upper cover, a main body lower cover covering the main body upper cover, an American standard pin assembly disposed between the main body upper cover and the main body lower cover, and a British standard pin assembly disposed between the main body upper cover and the main body lower cover; wherein at least one socket hole is defined on the main body upper cover;

wherein the overload protection device comprises:
a fuse holder, configured to be detachably mounted inside the main body lower cover;
a fuse tube, arranged within the fuse holder;
a lower conduction piece; and
an upper conduction piece, configured to be fixed between the main body upper cover and the main body lower cover; wherein an installation frame is formed inside the fuse holder, and the fuse tube is arranged within the installation frame;

wherein the lower conduction piece comprises a lower conduction clamping portion for clamping and conducting a lower part of the fuse tube; the British standard pin assembly and the American standard pin assembly are respectively capable of being inserted and connected to the lower conduction piece;

wherein the upper conduction piece comprises an upper conduction clamping portion for clamping and conducting an upper part of the fuse tube; the upper conduction piece is capable of being electrically connected to the at least one socket hole;

wherein an installation cover is formed on a lower end surface of the fuse holder; a fuse tube insertion hole for matching the installation cover is defined on the main body lower cover; at least one withdrawal clearance slot is recessed on a side edge of the fuse tube insertion hole;

wherein a gap is defined between the installation cover and the at least one withdrawal clearance slot, and the gap is suitable for insertion of a finger or a curved tool to lift the fuse holder along with the fuse tube arranged within the fuse holder.

In some embodiments, the lower conduction piece further includes a lower conduction connecting piece, an American standard clamping portion disposed on an end of the lower conduction connecting piece for insertion and electrical connection with the American standard pin assembly, and a British standard clamping portion disposed on another end of the lower conduction connecting piece for insertion and electrical connection with the British standard pin assembly; the lower conduction clamping portion is disposed on the other end of the lower conduction connecting piece.

In some embodiments, the lower conduction clamping portion includes lower conduction clamping arms respectively clamping both sides of the lower part of the fuse tube; a lower conduction upper guide block extending obliquely towards an external upper part is formed on an upper end of each lower conduction clamping arm, and a lower conduction lower guide block extending obliquely towards an external lower part is formed on a lower end of each lower conduction clamping arm.

In some embodiments, the upper conduction piece further includes an upper conduction connecting piece overall shaped as an “L”, and a socket hole connection clamping portion disposed on an end of the upper conduction connecting piece for electrical connection to the at least one socket hole; the upper conduction clamping portion is disposed on another end of the upper conduction connecting piece.

In some embodiments, the upper conduction clamping portion includes upper conduction clamping arms respectively clamping both sides of the upper part of the fuse tube and extending overall downward; at least one upper conduction guide block extending obliquely towards an external lower part is formed on a lower part of each upper conduction clamping arm.

In some embodiments, the installation frame is overall substantially rectangular or arc-shaped.

In some embodiments, at least one installation limiting portion extends outward from a side edge of the installation cover; a withdrawal guiding surface extending obliquely outward and downward from the installation cover is formed on an upper end surface of the at least one installation limiting portion; the at least one installation limiting portion matches the fuse tube insertion hole on the main body lower cover.

In some embodiments, at least one set of inner limiting protrusions arranged symmetrically protrudes from an inner wall of the installation frame, and a side of the fuse tube presses against the at least one set of inner limiting protrusions; a lower limiting protrusion protrudes from each of two outer lower ends of the installation frame, and a lower end of the fuse tube presses against the lower limiting protrusions on the two outer lower ends.

In some embodiments, an American standard live wire conduction piece is arranged on the American standard pin assembly, and the American standard live wire conduction piece is inserted into the American standard clamping portion in a case where the American standard pin assembly is pushed out of the main body lower cover.

In some embodiments, a British standard live wire conduction piece is arranged on the British standard pin assembly, and the British standard live wire conduction piece is inserted into the British standard clamping portion in a case where the British standard pin assembly is pushed out of the main body lower cover.

### BRIEF DESCRIPTION OF THE DRAWINGS

FIG. 1 is a schematic structural diagram of a fuse tube, a fuse holder, an upper conduction piece, and a lower conduction piece according to some embodiments of the present disclosure.

FIG. 2 is a schematic structural diagram of the upper conduction piece according to some embodiments of the present disclosure.

FIG. 3 is a schematic structural diagram of the lower conduction piece according to some embodiments of the present disclosure.

FIG. 4 is a schematic structural diagram of the fuse holder according to some embodiments of the present disclosure.

FIG. 5 is a schematic structural diagram of the fuse tube according to some embodiments of the present disclosure.

FIG. 6 is a rear schematic diagram of a power converter according to some embodiments of the present disclosure.

FIG. 7 is a rear schematic diagram of a power converter with a fuse tube and a fuse holder removed according to some embodiments of the present disclosure.

FIG. 8 is a front schematic diagram of a power converter according to some embodiments of the present disclosure.

FIG. 9 is an internal structural diagram of a power converter according to some embodiments of the present disclosure.

FIG. 10 is a schematic diagram of the connection between a conduction spring and an upper conduction piece according to some embodiments of the present disclosure.

FIG. 11 is a schematic diagram of an American standard pin assembly and a lower conduction piece according to some embodiments of the present disclosure.

FIG. 12 is a schematic diagram of the American standard pin assembly inserted into the lower conduction piece according to some embodiments of the present disclosure.

FIG. 13 is a schematic diagram of a British standard pin assembly and a lower conduction piece according to some embodiments of the present disclosure.

FIG. 14 is a schematic diagram of the British standard pin assembly inserted into the lower conduction piece according to some embodiments of the present disclosure.

FIG. 15 is another front schematic diagram of the power converter according to some embodiments of the present disclosure.

Reference numerals: 1, main body upper cover; 11, socket hole; 2, main body lower cover; 21, fuse tube insertion hole; 22, withdrawal clearance slot; 3, American standard pin assembly; 31, American standard live wire conduction piece; 4, British standard pin assembly; 41, British standard live wire conduction piece; 5, fuse holder; 51, installation frame; 511, inner limiting protrusion; 512, lower limiting protrusion; 52, installation cover; 521, installation limiting portion; 522, withdrawal guiding surface; 6, fuse tube; 7, lower conduction piece; 71, lower conduction clamping portion; 711, lower conduction clamping arm; 712, lower conduction upper guide block; 713, lower conduction lower guide block; 72, lower conduction connecting piece; 73, American standard clamping portion; 74, British standard clamping portion; 8, upper conduction piece; 81, upper conduction clamping portion; 811, upper conduction clamping arm; 812, upper conduction guide block; 82, upper conduction connecting piece; 83, socket hole connection clamping portion.

### DETAILED DESCRIPTION

To further elaborate on the technical means and effects adopted by the present disclosure to achieve the intended purpose, the specific embodiments of the present disclosure are described in detail below in conjunction with the accompanying drawings and some embodiments.

In the description of the present disclosure, it should be understood that the orientation or positional relationships indicated by terms such as “length”, “width”, “upper”, “lower”, “front”, “rear”, “left”, “right”, “vertical”, “horizontal”, “top”, “bottom”, “inner”, “outer” are based on the orientation or positional relationships shown in the drawings. They are only for the convenience of describing the present disclosure and simplifying the description, and do not indicate or imply that the referred device or element must have a specific orientation, be constructed and operated in a specific orientation. Therefore, they should not be construed as limiting the present disclosure.

Furthermore, the terms “first” and “second” are used for descriptive purposes only and should not be construed as indicating or implying relative importance or implicitly indicating the quantity of the indicated technical features. Thus, features defined as “first” and “second” may explicitly or implicitly include one or more of such features. In the description of the present disclosure, “plurality” means two or more, unless otherwise expressly and specifically defined.

In the present disclosure, unless otherwise expressly specified and limited, terms such as “mounted”, “connected”, “linked”, “fixed” should be interpreted broadly. For example, it may be a fixed connection, a detachable connection, or an integral connection; it may be a mechanical connection, an electrical connection; it may be a direct connection, an indirect connection through an intermediary, or the internal communication between two elements or the interaction between two elements. Those of ordinary skill in the art can understand the specific meanings of the above terms in the present disclosure according to the specific circumstances.

### Embodiment 1

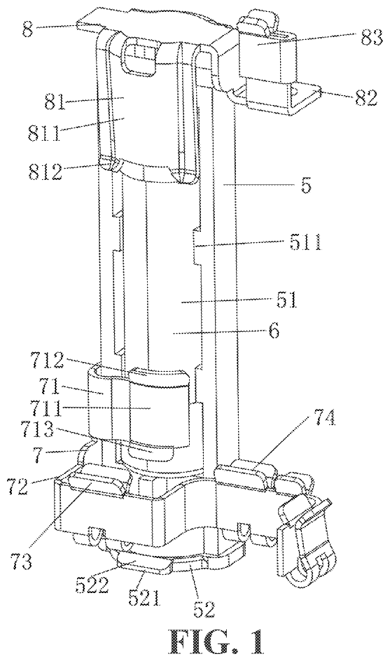

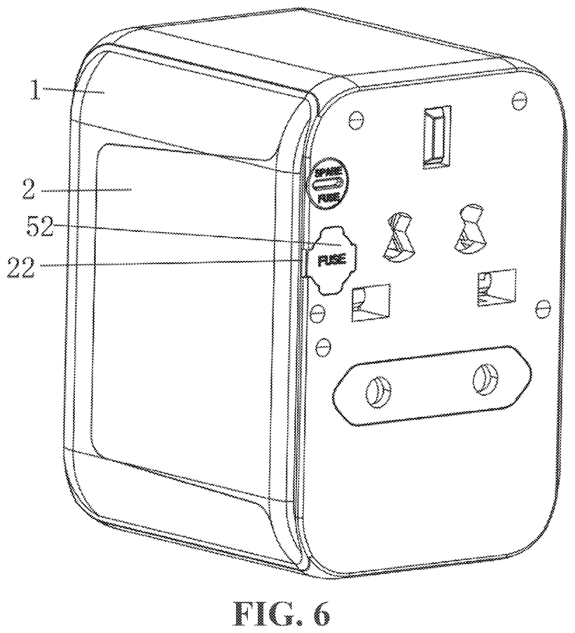

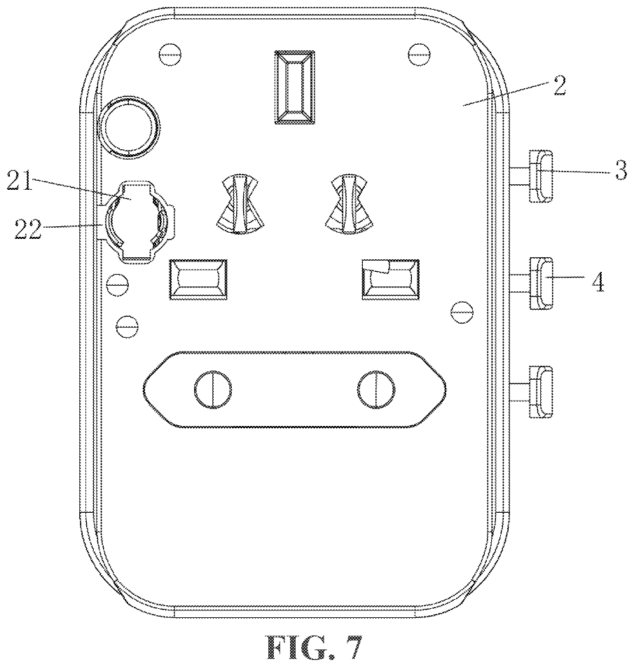

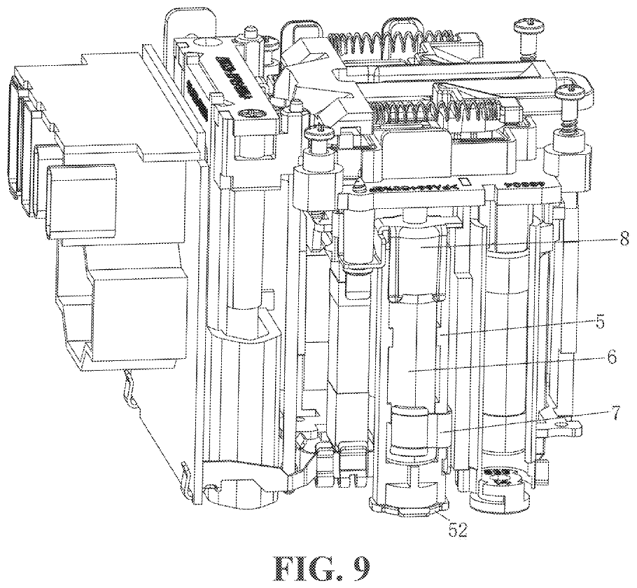

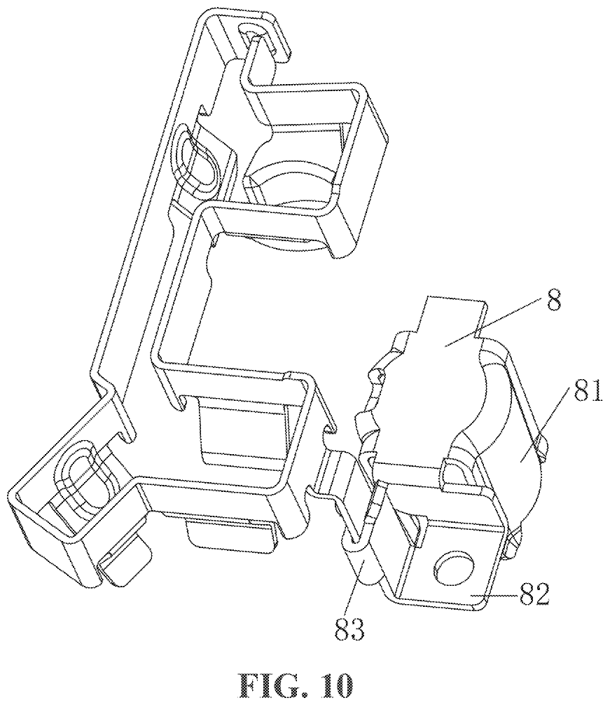

Referring to FIGS. 1 to 14, some embodiments of the present disclosure provide an overload protection device for a multi-national power converter. The multi-national power converter includes a main body upper cover 1, a main body lower cover 2 covering the main body upper cover 1, an American standard pin assembly 3 disposed between the main body upper cover 1 and the main body lower cover 2, and a British standard pin assembly 4 disposed between the main body upper cover 1 and the main body lower cover 2. A socket hole 11 is defined on the main body upper cover 1. The overload protection device includes a fuse holder 5 detachably mounted inside the main body lower cover 2, a fuse tube 6 arranged within the fuse holder 5, a lower conduction piece 7 fixed on the main body lower cover 2, and an upper conduction piece 8 fixed between the main body upper cover 1 and the main body lower cover 2. An installation frame 51 is formed inside the fuse holder 5, and the fuse tube 6 is arranged within the installation frame 51. The lower conduction piece 7 includes a lower conduction clamping portion 71 for clamping and conducting a lower part of the fuse tube 6. The British standard pin assembly 4 and the American standard pin assembly 3 are respectively inserted and connected to the lower conduction piece 7. The upper conduction piece 8 includes an upper conduction clamping portion 81 for clamping and conducting an upper part of the fuse tube 6. The upper conduction piece 8 is electrically connected to the socket hole 11.

The fuse holder 5 is configured to fix a position of the fuse tube 6, preventing the fuse tube 6 from moving inside the power converter, making it easier for the upper conduction piece 8 and the lower conduction piece 7 to clamp, thereby ensuring conductive connection between the fuse tube 6 and a live wire on the socket hole 11 and live wires of the British standard pin assembly 4 and the American standard pin assembly 3, and thus improving the safety of the power converter. After installing the fuse holder 5 and fuse tube 6 inside the power converter via the main body lower cover 2, the upper conduction clamping portion 81 of the upper conduction piece 8 clamps the upper part of the fuse tube 6, thereby electrically connecting an end of the fuse tube 6 to a live wire of a multi-national plug (e.g. a British standard plug, an American standard plug, etc.) inserted into the socket hole 11. The lower conduction clamping portion 71 of the lower conduction piece 7 clamps the lower part of the fuse tube 6, thereby connecting the other end of the fuse tube 6 to live wire pins of the American standard pin assembly 3 and the British standard pin assembly 4. The combination of the two ensures smooth conduction and high safety for this device, effectively protecting the circuit in the power converter, preventing circuit overload, while allowing for a more compact product size.

For the specific structural configuration of the lower conduction piece 7, as shown in FIGS. 1, 3, 9, 11 to 14, the lower conduction piece 7 further includes a lower conduction connecting piece 72, an American standard clamping portion 73 disposed on an end of the lower conduction connecting piece 72 for insertion and electrical connection with the American standard pin assembly 3, and a British standard clamping portion 74 disposed on the other end of the lower conduction connecting piece 72 for insertion and electrical connection with the British standard pin assembly 4. The lower conduction clamping portion 71 is disposed on the other end of the lower conduction connecting piece 72. The lower conduction piece 7 may be an integrally formed structure, ensuring smooth conduction and improving conduction efficiency between its components. One end of the lower conduction connecting piece 72 extends upward to connect to the lower end of the lower conduction clamping portion 71, while the other end of the lower conduction connecting piece 72 is formed with the American standard clamping portion 73 and the British standard clamping portion 74. When the American standard pin assembly 3 is required to be used, a user may simply push the American standard pin assembly 3 out of the main body lower cover 2 from inside the power converter. In this case, the American standard pin assembly 3 is inserted into the American standard clamping portion 73, achieving conductive connection between the live wire pin of the American standard pin assembly 3 and the fuse tube 6. When the American standard pin assembly 3 is not needed, it is disconnected from the American standard clamping portion 73, effectively ensuring the safety of using the American standard pin assembly 3. When the British standard pin assembly 4 is required to be used, the user may simply push the British standard pin assembly 4 out of the main body lower cover 2 from inside the power converter. In this case, the British standard pin assembly 4 is inserted into the British standard clamping portion 74, achieving conductive connection between the live wire pin of the British standard pin assembly 4 and the fuse tube 6. When the British standard pin assembly 4 is not needed, it is disconnected from the British standard clamping portion 74, effectively ensuring the safety of using the British standard pin assembly 4.

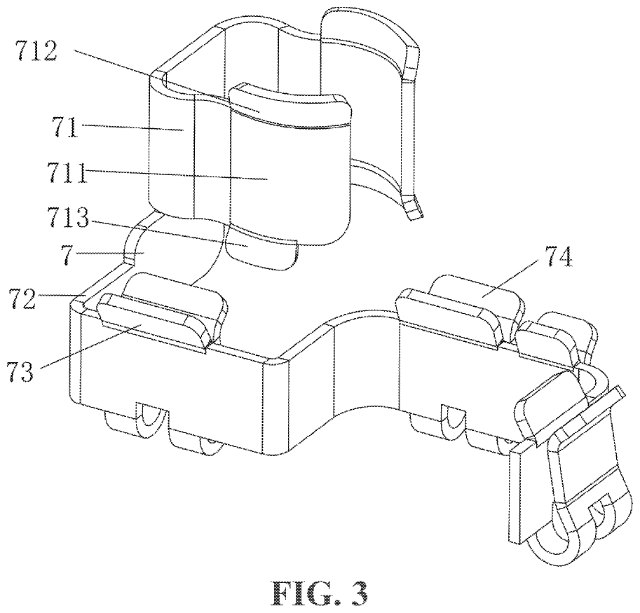

For the specific structural configuration of the lower conduction connecting piece 72, as shown in FIGS. 1 and 3, the shape of the lower conduction connecting piece 72 may be set according to actual needs. For example, in some embodiments, to avoid the live wire pin of the British standard pin assembly 4, the lower conduction connecting piece 72 is arranged in a bent shape.

For the specific structural configuration of the lower conduction clamping portion 71, as shown in FIGS. 1 and 3, the lower conduction clamping portion 71 includes lower conduction clamping arms 711 respectively clamping both sides of the lower part of the fuse tube 6. A lower conduction upper guide block 712 extending obliquely towards an external upper part is formed on an upper end of each lower conduction clamping arm 711. A lower conduction lower guide block 713 extending obliquely towards an external lower part is formed on a lower end of each lower conduction clamping arm 711. The two sets of lower conduction clamping arms 711 clamp both sides of the lower part of the fuse tube 6 respectively, ensuring conductive connection between the fuse tube 6 and the live wires of the British standard pin assembly 4 and the American standard pin assembly 3, thereby preventing the fuse tube 6 from moving during use, and improving conduction efficiency. When the fuse tube 6 and the fuse holder 5 are required to be removed from the power converter, under a guiding action of the lower conduction upper guide blocks 712, the fuse tube 6 and the fuse holder 5 may be easier and more accurately removed from the lower conduction clamping portion 71, thereby improving the removal efficiency of the fuse tube 6 and fuse holder 5. After removal, the fuse tube 6 within the fuse holder 5 may be freely replaced for a next use. When the fuse tube 6 and the fuse holder 5 are required to be arranged into the power converter, under a guiding action of the lower conduction lower guide blocks 713, the fuse tube 6 and the fuse holder 5 may be easier and more accurately inserted into the lower conduction clamping portion 71, where they are clamped by the lower conduction clamping portion 71 for conduction, thereby completing the installation of the fuse tube 6 and improving the installation efficiency of the fuse tube 6 and the fuse holder 5.

For the specific structural configuration of the upper conduction piece 8, as shown in FIGS. 1, 2, 9, and 10, the upper conduction piece 8 further includes an upper conduction connecting piece 82 overall shaped as an “L”, and a socket hole connection clamping portion 83 disposed on an end of the upper conduction connecting piece 82 for electrical connection to the socket hole 11. The upper conduction clamping portion 81 is disposed on the other end of the upper conduction connecting piece 82. The upper conduction piece 8 may be an integrally formed structure, ensuring smooth conduction and improving conduction efficiency between its components. The upper conduction connecting piece 82 is shaped like an “L”, which effectively reserves a fixing position for the upper conduction piece 8, facilitating screws to fix the upper conduction piece 8 onto internal components of the power converter (e.g., fixed onto a lower surface of a bracket as in China Patent with Application No. 202021218777.2, titled “Anti-Single-Insertion Protection Gate Assembly for Multi-national Power Converter”). The upper conduction clamping portion 81 is disposed on an upward-extending end of the upper conduction connecting piece 82 and extends overall downward to clamp the fuse tube 6. The socket hole connection clamping portion 83 is disposed on a transverse end of the upper conduction connecting piece 82 and extends overall upward to clamp a corresponding conduction spring associated with the socket hole 11 (e.g., a downward-extending end of a right socket spring assembly as in China Patent with Application No. 201621114014.7, titled “Right Socket Spring Assembly for Multi-national Power Converter”, is inserted into the socket hole connection clamping portion 83), thereby achieving conduction between the multi-national plug inserted into the socket hole 11 and the respective pin assemblies.

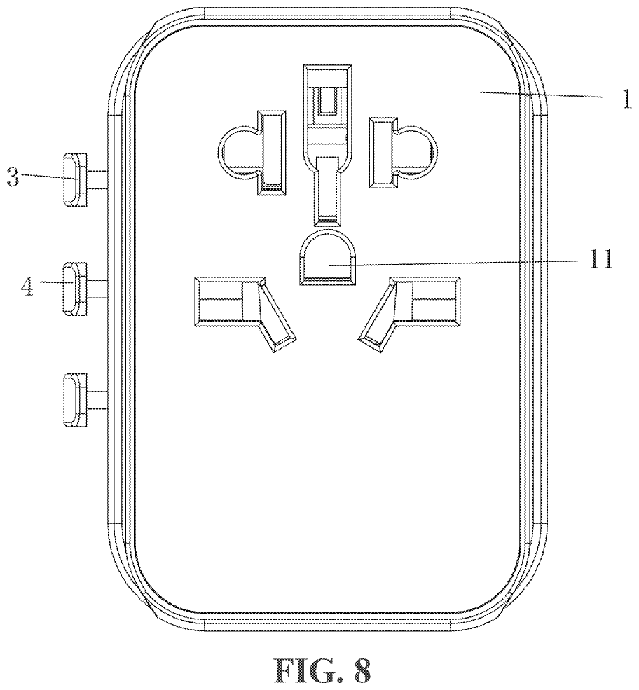

For the specific structural configuration of the socket hole 11, as shown in FIG. 8, reference may be made to China Patent with Application No. 201621114014.7, titled “Multi-national Power Converter”, regarding the description of the structure and related principles of a single socket panel or combined socket panel. Therefore, it is not elaborated in the embodiments.

For the specific structural configuration of the upper conduction clamping portion 81, as shown in FIGS. 1, 2, 9, and 10, the upper conduction clamping portion 81 includes upper conduction clamping arms 811 respectively clamping both sides of the upper part of the fuse tube 6 and extending overall downward. At least one upper conduction guide block 812 extending obliquely towards an external lower part is formed on a lower part of each upper conduction clamping arm 811. The two sets of upper conduction clamping arms 811 clamp the upper part of the fuse tube 6, enabling conductive connection between the fuse tube 6 and the live wire on the socket hole 11 of the power converter. When installing the fuse tube 6 and the fuse holder 5, the upper end of the fuse tube 6 first contacts the upper conduction guide blocks 812. Under a guiding action of the upper conduction guide blocks 812, the fuse tube 6 is guided to insert into the upper conduction clamping arms 811, making it easier and more accurate to insert the fuse tube 6 into the upper conduction clamping portion 81, preventing displacement. Further, the fuse tube 6 is clamped by the upper conduction clamping portion 81 for conduction, completing the installation of the fuse tube 6 and improving installation efficiency.

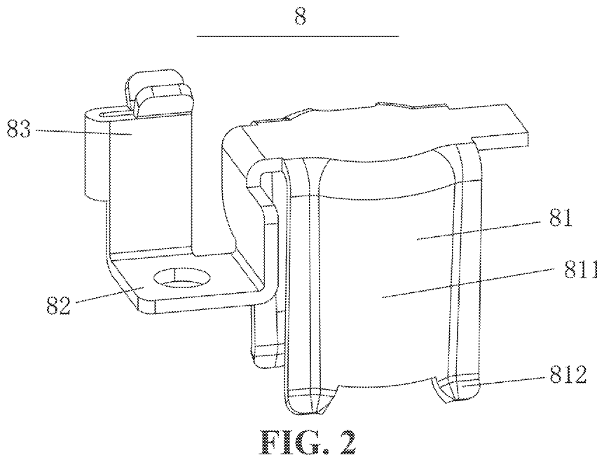

Specifically, as shown in FIGS. 1 and 2, the upper conduction guide block 812 is formed on each of the two lower sides of each upper conduction clamping arm 811, totaling four upper conduction guide blocks 812. The four upper conduction guide blocks 812 may guide all four corners of the fuse tube 6, making the insertion of the fuse tube 6 into the center of the upper conduction clamping portion 81 more precise, completing the conductive connection.

For the specific method of installing the fuse holder 5 and fuse tube 6 into the power converter, as shown in FIGS. 1, 4, 6, and 7, an installation cover 52 is formed on a lower end surface of the fuse holder 5. At least one installation limiting portion 521 extends outward from a side edge of the installation cover 52. A withdrawal guiding surface 522 extending obliquely outward and downward from the installation cover 52 is formed on an upper end surface of the installation limiting portion 521. A fuse tube insertion hole 21 matching the installation cover 52 and the installation limiting portion 521 is defined on the main body lower cover 2. At least one withdrawal clearance slot 22 is recessed on a side edge of the fuse tube insertion hole 21. The fuse holder 5 and fuse tube 6 are inserted into the power converter through the fuse tube insertion hole 21. The installation limiting portion 521 presses against the side edge of the fuse tube insertion hole 21, preventing the fuse tube 6 from being inserted too deeply into the power converter. When the fuse tube 6 is required to be removed, the user may simply insert a finger or tool between the withdrawal clearance slot 22 and the withdrawal guiding surface 522, then lift the installation limiting portion 521 along an extension direction of the withdrawal guiding surface 522 to remove the fuse holder 5 and the fuse tube 6 arranged within the fuse holder 5. The entire process is simple and convenient, improving removal efficiency.

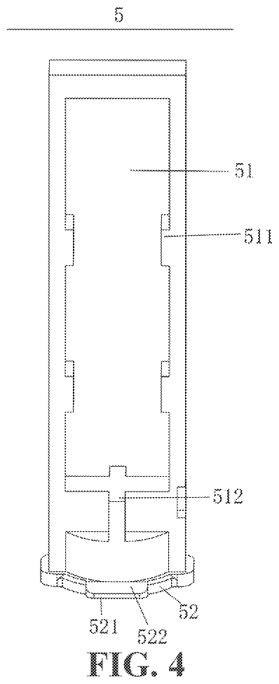

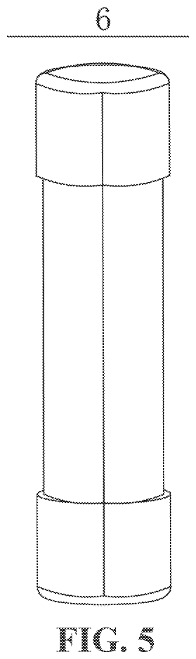

For the installation frame 51, as shown in FIGS. 4 and 5, the installation frame 51 may be overall rectangular or arc-shaped. A specific choice may be made according to actual situations. In some embodiments, a rectangular shape is chosen to match the fuse tube 6.

For the specific method of installing the fuse tube 6 inside the installation frame 51, as shown in FIG. 4, at least one set of inner limiting protrusions 511 arranged symmetrically protrudes from an inner wall of the installation frame 51. A side of the fuse tube 6 presses against these inner limiting protrusions 511. A lower limiting protrusion 512 protrudes from each of two outer lower ends of the installation frame 51. A lower end of the fuse tube 6 presses against these lower limiting protrusions 512. The combination of the lower end of the fuse tube 6 and the lower limiting protrusions 512 may stably fix the fuse tube 6 inside the installation frame 51, making it less prone to displacement, thereby ensuring smooth conduction and high safety for this device, effectively protecting the circuit in the power converter and preventing circuit overload.

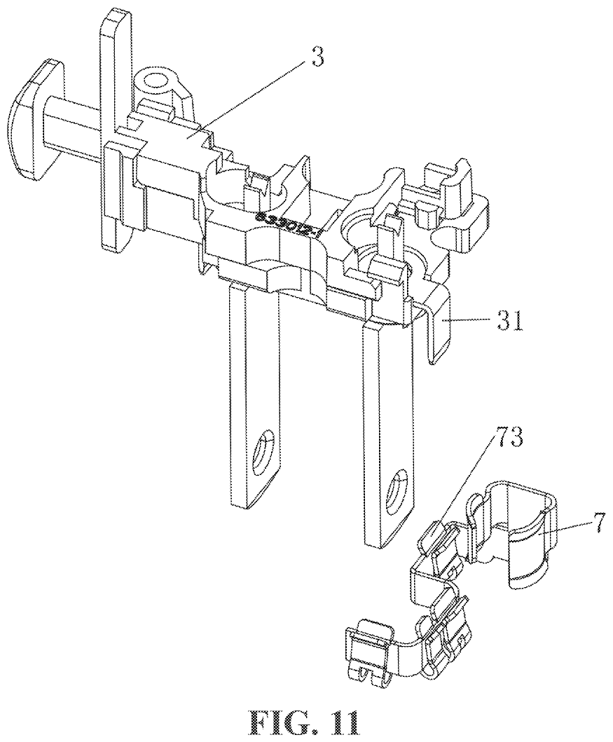

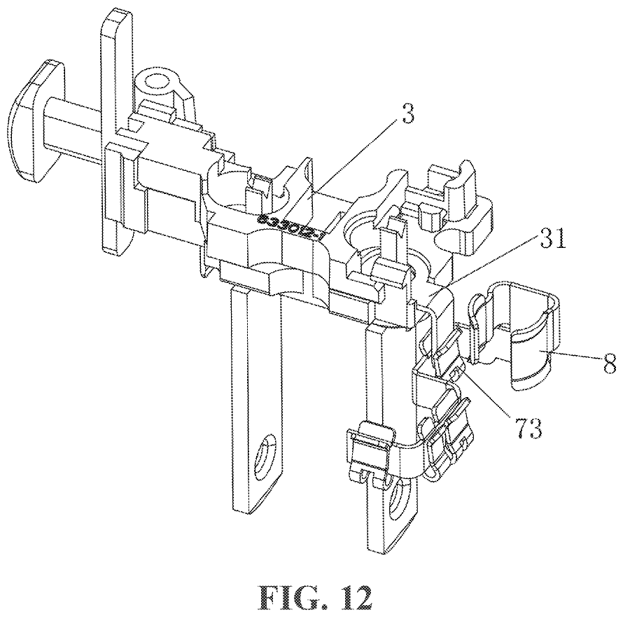

For the specific insertion method between the American standard pin assembly 3 and the lower conduction piece 7, as shown in FIGS. 11 to 12, an American standard live wire conduction piece 31 is arranged on the American standard pin assembly 3. The American standard live wire conduction piece 31 is inserted into the American standard clamping portion 73 when the American standard pin assembly 3 is pushed out of the main body lower cover 2. In this way, the American standard pin assembly 3 is conducted to the lower conduction piece 7, the lower conduction piece 7 is conducted to the fuse tube 6, an upper end of the fuse tube 6 is conducted to the upper conduction piece 8, and the upper conduction piece 8 is conducted to the conduction spring on the bracket. After the multi-national plug requiring conversion is inserted into the socket hole 11, it is conducted to the conduction spring, completing the entire conduction structure smoothly. When not in use, the American standard live wire conduction piece 31 is away from the American standard clamping portion 73, ensuring the American standard live wire conduction piece 31 is not conducted to the external plug, enhancing the safety of the power converter. For the specific structural configuration of the American standard pin assembly 3, reference may be made to China Patent with Application No. 202010597132.2, titled “Multi-Channel Sliding Small Plug”, regarding the structure and usage principles of the second pin assembly, etc. Therefore, it is not elaborated in the embodiments.

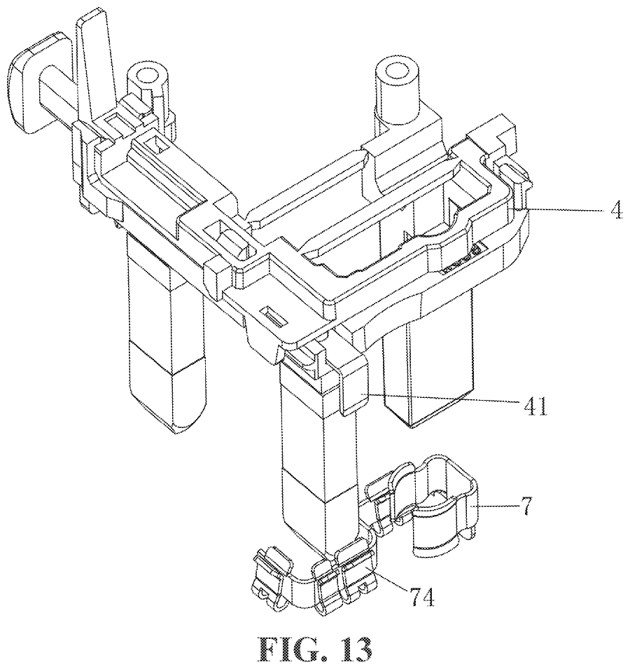

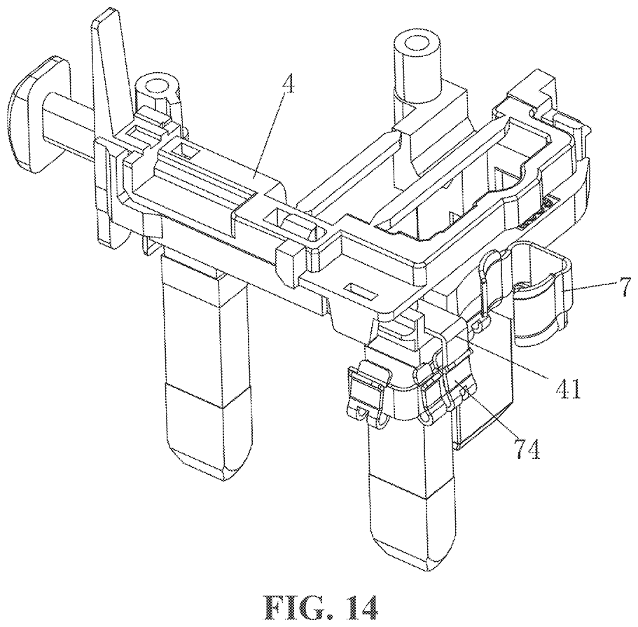

For the specific insertion method between the British standard pin assembly 4 and the lower conduction piece 7, as shown in FIGS. 13 to 14, a British standard live wire conduction piece 41 is arranged on the British standard pin assembly 4. The British standard live wire conduction piece 41 is inserted into the British standard clamping portion 74 when the British standard pin assembly 4 is pushed out of the main body lower cover 2. In this way, the British standard pin assembly 4 is conducted to the lower conduction piece 7, the lower conduction piece 7 is conducted to the fuse tube 6, the upper end of the fuse tube 6 is conducted to the upper conduction piece 8, and the upper conduction piece 8 is conducted to the conduction spring on the bracket. After the multi-national plug requiring conversion is inserted into the socket hole 11, it is conducted to the conduction spring, completing the entire conduction structure smoothly. When not in use, the British standard live wire conduction piece 41 is away from the British standard clamping portion 74, ensuring the British standard live wire conduction piece 41 is not conducted to the external plug, enhancing the safety of the power converter. For the specific structural configuration of the British standard pin assembly 4, reference may be made to China Patent with Application No. 202010597132.2, titled “Multi-Channel Sliding Small Plug”, regarding the structure and usage principles of the second pin assembly, etc. Therefore, it is not elaborated in the embodiments.

### Embodiment 2

In the Embodiment 1, the structure of the overload protection device is described. In Embodiment 2, the main differences from other embodiments are explained, and the same structures are not repeated.

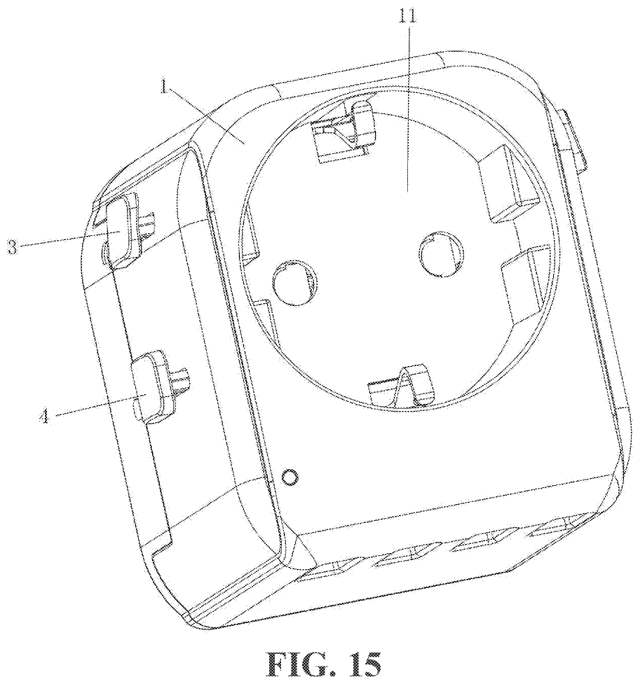

The main difference between Embodiment 2 and Embodiment 1 is that, referring to FIG. 15, the socket hole 11 is a German-style socket panel, meeting people's needs for different sockets under different circumstances, improving the practicality of the device, and expanding its application scope. The German-style socket panel is a standard panel, so it is not elaborated in the embodiments.

It should be noted here that the overload protection device for a multi-national power converter disclosed in the present disclosure is an improvement to the specific structure, while the specific control method is not the innovative point of the present disclosure. Components such as the fuse tube, conduction spring, and other parts involved in the present disclosure may be general standard parts or parts known to those skilled in the art. Their structure, principles, and control methods are known to those skilled in the art through technical manuals or obtained through conventional experimental methods.

The above descriptions are only some embodiments of the present disclosure and are not intended to limit the technical scope of the present disclosure in any way. Therefore, other structures obtained using the same or similar technical features as the above embodiments of the present disclosure are all within the scope of the present disclosure.

What is claimed is:

1. An overload protection device for a multi-national power converter;
wherein the multi-national power converter comprises a main body upper cover, a main body lower cover covering the main body upper cover, an American standard pin assembly disposed between the main body upper cover and the main body lower cover, and a British standard pin assembly disposed between the main body upper cover and the main body lower cover; wherein at least one socket hole is defined on the main body upper cover;
wherein the overload protection device comprises:
a fuse holder, configured to be detachably mounted inside the main body lower cover;
a fuse tube, arranged within the fuse holder;
a lower conduction piece; and
an upper conduction piece, configured to be fixed between the main body upper cover and the main body lower cover; wherein an installation frame is formed inside the fuse holder, and the fuse tube is arranged within the installation frame;
wherein the lower conduction piece comprises a lower conduction clamping portion for clamping and conducting a lower part of the fuse tube; the British standard pin assembly and the American standard pin assembly are respectively capable of being inserted and connected to the lower conduction piece;
wherein the upper conduction piece comprises an upper conduction clamping portion for clamping and conducting an upper part of the fuse tube; the upper conduction piece is capable of being electrically connected to the at least one socket hole;
wherein an installation cover is formed on a lower end surface of the fuse holder; a fuse tube insertion hole for matching the installation cover is defined on the main body lower cover; at least one withdrawal clearance slot is recessed on a side edge of the fuse tube insertion hole;
wherein a gap is defined between the installation cover and the at least one withdrawal clearance slot, and the gap is suitable for insertion of a finger or a curved tool to lift the fuse holder along with the fuse tube arranged within the fuse holder.

2. The overload protection device according to claim 1, wherein the lower conduction piece further comprises a lower conduction connecting piece, an American standard clamping portion disposed on a first end of the lower conduction connecting piece for insertion and electrical connection with the American standard pin assembly, and a British standard clamping portion disposed on a second end of the lower conduction connecting piece for insertion and electrical connection with the British standard pin assembly; the lower conduction clamping portion is disposed on the second end of the lower conduction connecting piece.

3. The overload protection device according to claim 1, wherein the lower conduction clamping portion comprises lower conduction clamping arms respectively clamping both sides of the lower part of the fuse tube; a lower conduction upper guide block extending obliquely towards an external upper part is formed on an upper end of each of the lower conduction clamping arms, and a lower conduction lower guide block extending obliquely towards an external lower part is formed on a lower end of each of the lower conduction clamping arms.

4. The overload protection device according to claim 1, wherein the upper conduction piece further comprises an upper conduction connecting piece overall shaped as an “L”, and a socket hole connection clamping portion disposed on a first end of the upper conduction connecting piece for electrical connection to the at least one socket hole; the upper conduction clamping portion is disposed on a second end of the upper conduction connecting piece.

5. The overload protection device according to claim 1, wherein the upper conduction clamping portion comprises upper conduction clamping arms respectively clamping both sides of the upper part of the fuse tube and extending overall downward; at least one upper conduction guide block extending obliquely towards an external lower part is formed on a lower part of each of the upper conduction clamping arms.

6. The overload protection device according to claim 1, wherein at least one set of inner limiting protrusions arranged symmetrically protrudes from an inner wall of the installation frame, and a side of the fuse tube presses against the at least one set of inner limiting protrusions; a lower limiting protrusion protrudes from each of two outer lower ends of the installation frame, and a lower end of the fuse tube presses against the lower limiting protrusions on the two outer lower ends.

7. The overload protection device according to claim 2, wherein an American standard live wire conduction piece is arranged on the American standard pin assembly, and the American standard live wire conduction piece is inserted into the American standard clamping portion in a case where the American standard pin assembly is pushed out of the main body lower cover.

8. The overload protection device according to claim 2, wherein a British standard live wire conduction piece is arranged on the British standard pin assembly, and the British standard live wire conduction piece is inserted into the British standard clamping portion in a case where the British standard pin assembly is pushed out of the main body lower cover.

9. The overload protection device according to claim 1, wherein the installation frame is overall substantially rectangular or arc-shaped.

10. The overload protection device according to claim 1, wherein at least one installation limiting portion extends outward from a side edge of the installation cover; a withdrawal guiding surface extending obliquely outward and downward from the installation cover is formed on an upper end surface of the at least one installation limiting portion; the at least one installation limiting portion matches the fuse tube insertion hole on the main body lower cover.
